(19) United States
(12) Patent Application Publication
(10) Pub. No.: US 2008/0141763 A1
(43) Pub. Date: Jun. 19, 2008

(54) Portable Magnetic Hardness Tester

(76) Inventor: Margareta Antonescu, Edmonton (CA)

Correspondence Address: Margareta Antonescu, 4221 Terwillegar Vista, Edmonton, AB, T6R 2Y7, omitted

(21) Appl. No.: 11/757,387

(22) Filed: Jun. 3, 2007

(30) Foreign Application Priority Data
Dec. 19, 2006 (CA) 2,568,089

(51) Int. Cl. G01N 3/48

(52) U.S. Cl. 73/81

(57) ABSTRACT

The portable magnetic hardness tester support assembly is made for testing the hardness of small or large ferrous metallic specimens. The hardness tester is made up of a hardness tester head which uses the standard test method for Rockwell hardness testing and of a magnet, the two of which are held together by a nonmagnetic support body. The portable magnetic hardness tester attaches to the specimen through the magnetic force generated by the magnet.

A patent application for the portable magnetic hardness tester is pending in Canada, Canadian Patent Application No. 2,568,089, filed Nov. 11, 2006.

### BACKGROUND OF THE INVENTION

1. Field of the Invention

The portable magnetic hardness tester support assembly relates to measuring and testing devises. More specifically, the invention is a system design and constructed to support a hardness tester head and a magnet.

2. Description of the Prior Art

The most import aspects of the invention are that it is portable and easy to use, therefore allowing for small and large ferrous metallic parts to be readily tested. The portable magnetic hardness tester support assembly is made precisely for testing the hardness of metallic materials used in construction.

The present invention is designed for shop or field use and conforms to the stringent requirements of ASTM E 110 Standard Test Method for Indentation Hardness of Metallic Materials by Portable Hardness Testers and the ASTM E 18 Standard Test Method for Indentation Hardness Testing of Metallic Materials.

### SUMMARY OF THE INVENTION

The present invention is a new design for portable hardness testers. It is designed to meet stringent quality and specification requirements for the hardness testing of ferrous metallic materials. With many hardness testers of the prior art, it is necessary to bring the material to the hardness tester or improvise a holding device. The present invention addresses these problems.

This portable magnetic hardness tester is designed to be portable and to accommodate either flat or round surfaces of small or large ferrous metallic specimens.

Accordingly, the invention presents an alternative, improved option for the hardness testing of ferrous metallic specimens because its ease of use and because it saves considerable effort and time.

### BRIEF DESCRIPTION OF THE DRAWINGS

FIG. 1 is a front view of the portable magnetic hardness tester according to present invention showing the components of the invention when the invention is not engaged on specimen A.

FIG. 2 is a side view of the portable magnetic hardness tester according to present invention showing the magnet and the hardness tester head when the invention is not engaged on specimen A

FIG. 3 is a front view of the portable magnetic hardness tester according to present invention showing the magnet when engaged on specimen A and the hardness tester head lever in minor load position.

FIG. 4 is a side view of the portable magnetic hardness tester according to present invention showing the magnet when engaged on specimen A and the hardness tester head lever in minor load position.

FIG. 5 is a front view of the portable magnetic hardness tester according to present invention showing the magnet when engaged on the specimen A and the hardness tester head in major load position.

FIG. 6 is a side view of the portable magnetic hardness tester according to present invention showing the magnet when engaged and the hardness tester head in major load position.

FIG. 7 is a section view of the nonmagnetic support body according to present invention.

FIG. 8 is a top view of the nonmagnetic support body according to present invention

FIG. 9 is a side view of the nonmagnetic support handle according to present invention.

FIG. 10 is a front view of the nonmagnetic handle according to present invention.

FIG. 11 is a section view of the nonmagnetic handle support according to present invention.

### DETAILED DESCRIPTION OF THE PREFERRED EMBODIMENT

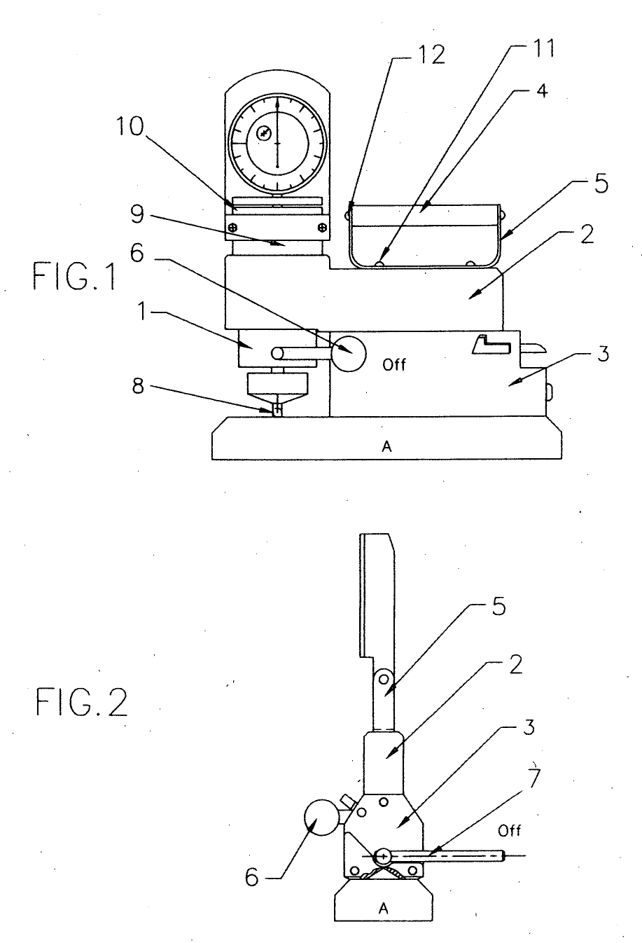

The portable magnetic hardness tester FIG. 1 is made for testing the hardness of ferrous metallic specimen.

The portable magnetic hardness tester FIG. 1 is composed of a nonmagnetic support body 2 which holds together a hardness tester head 1, a magnet 3, a nonmagnetic handle support 5 and a nonmagnetic handle 4. The hardness tester head 1 is attached to the nonmagnetic support body 2 by means of a threaded nut and a teflon spacer 9. The magnet 3 is attached to the nonmagnetic support body 2 and to the nonmagnetic support handle 5 by means of two threaded bolts 11 which penetrate the nonmagnetic support body 2. The nonmagnetic handle support 5 contains two bottom holes allowing attachment to the magnet 3 through the nonmagnetic support body 2 and another two top holes allowing attachment to the nonmagnetic handle 4. The nonmagnetic handle 4 has two threaded holes on each side which allow attachment to the nonmagnetic handle support. Further, the portable magnetic hardness tester FIG. 1 is comprised of two threaded bolts 12 which attach the nonmagnetic handle to the handle support and also of another two threaded bolts 11 which attach the nonmagnetic support handle to the magnet 3 through the nonmagnetic support body 2. The magnet 3 in FIG. 1 attaches the whole hardness tester assembly to the ferrous part to be tested A by means of a lever 7 which engages the magnet by reducing the air gap between the magnet and the ferrous part to be tested A.

The hardness tester head 1 may be any hardness tester head known which can be used for the Rockwell method of indentation, such of Rockwell B scale having a 100 Kg load and a tungsten carbide ball penetrator 8, or Rockwell C scale having a 150 Kg load and a 120 degree diamond cone penetrator.

In FIG. 1 and FIG. 2, the hardness tester load lever 6 and magnet lever 7 are in “OFF” position.

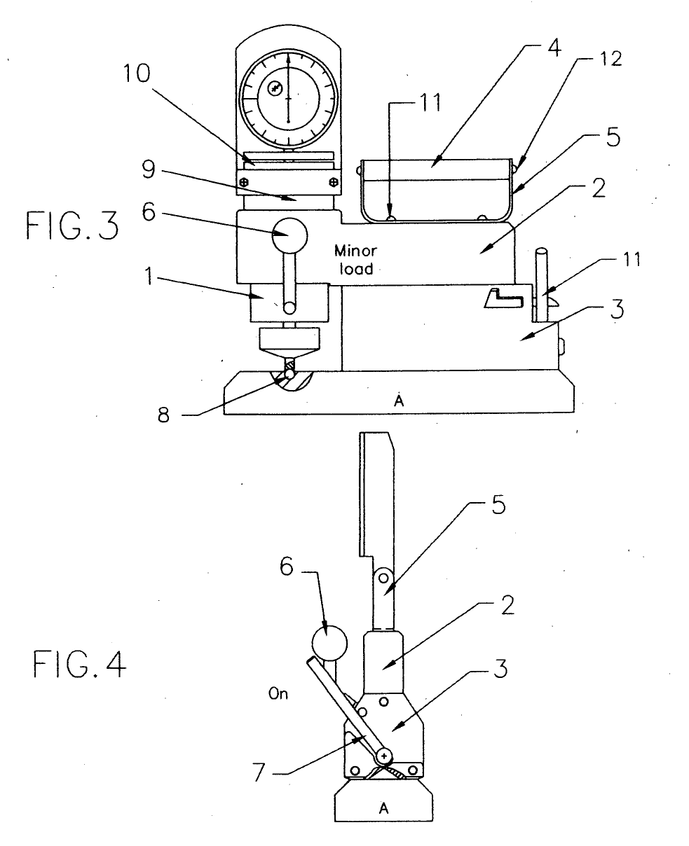

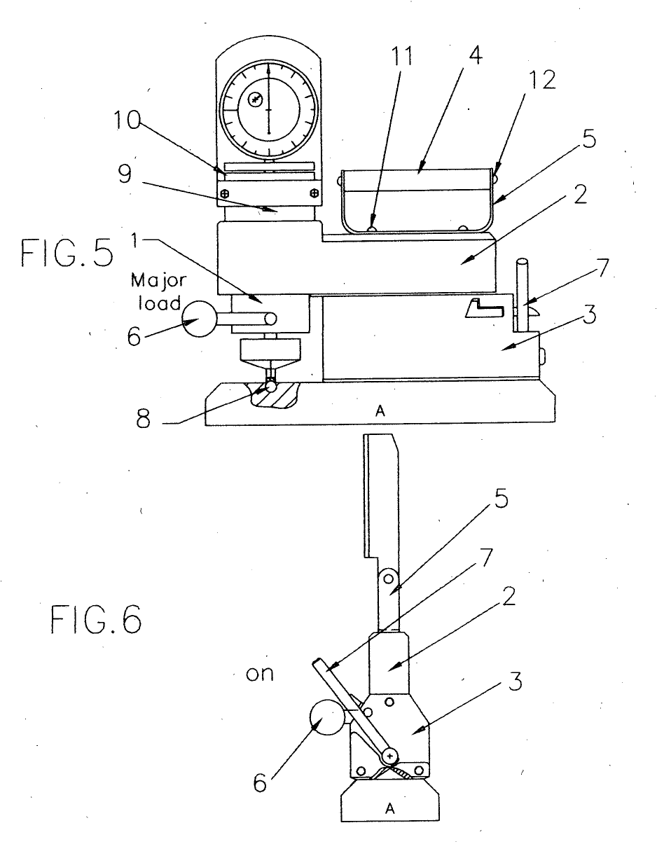

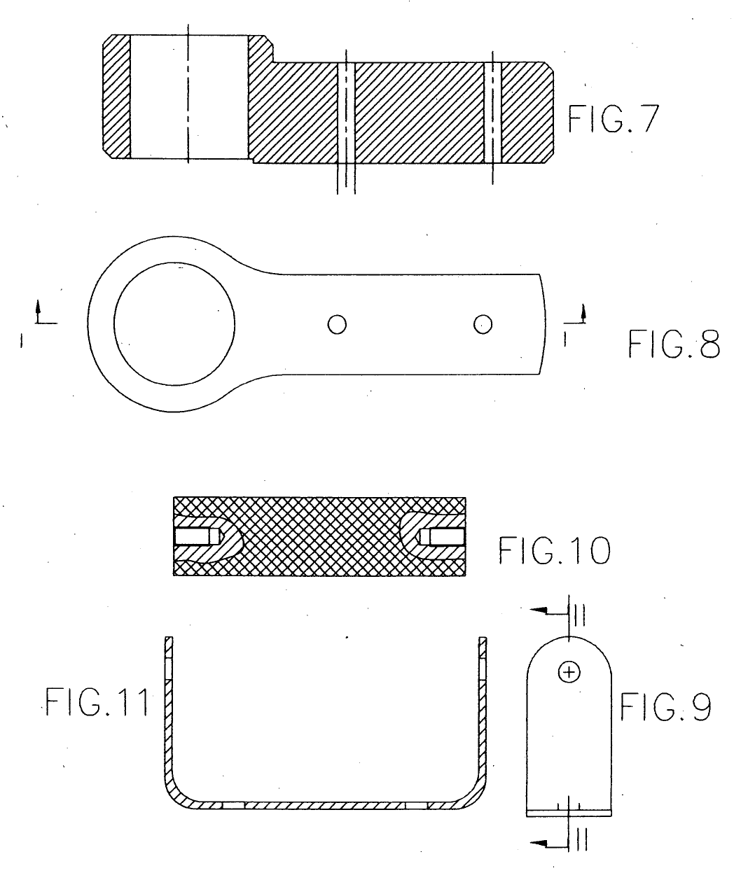

The versatility of the nonmagnetic support body 2 is illustrated in FIG. 3, FIG. 4, FIG. 5 and FIG. 6 where both levers 6 and 7 are engaged. As shown in these drawings the nonmagnetic support body holds together two major components of the hardness tester assembly which have major forces working in opposition with one another. The force of the magnet is twice that of the force applied by the hardness tester head load.

I claim:

1. A portable magnetic hardness tester support assembly for use with a hardness tester head in conjunction with a magnet in order to test the hardness of metallic materials comprising:
a nonmagnetic support body;
a nonmagnetic handle support;
a nonmagnetic handle; and
a nonmagnetic spacer ring.

2. The portable magnetic hardness tester support assembly as specified in claim 1, wherein the hardness tester head uses the standard test method for Rockwell hardness testing of metallic materials.

3. The portable magnetic hardness tester support assembly as specified in claim 1, wherein the hardness tester head is vertically attached to one side of the nonmagnetic support body by a threaded nut and a nonmagnetic spacer ring.

4. The portable magnetic hardness tester support assembly as specified in claim 1, wherein the other side of the nonmagnetic support body is attached to the upper side of a magnet and to the nonmagnetic handle support by screws.

5. The portable magnetic hardness tester support assembly as specified in claim 1, wherein the nonmagnetic handle is attached to the nonmagnetic handle support by screws.

6. The portable magnetic hardness tester support assembly according to claim 1, wherein the magnet includes a clamping mechanism and a lever.

7. The portable magnetic hardness tester support assembly as specified in claim 1, wherein the magnet includes an inverted “V”-shaped groove which accommodates either the flat or the round surface of ferrous materials to be tested.

8. The portable magnetic hardness tester support assembly as specified in claim 1, wherein the nonmagnetic support body is precisely machined and press fit connected with the hardness tester head.

9. The portable magnetic hardness tester support assembly specified in claim 1 wherein the nonmagnetic support body, the nonmagnetic handle support and the nonmagnetic handle are made of nonmagnetic materials in order to avoid any interference between the magnetic force generated by the magnet while engaged on the specimen to be tested and the applied force of the hardness tester head during the hardness test.
